(19) United States
(12) Patent Application Publication
(10) Pub. No.: US 2010/0264348 A1
(43) Pub. Date: Oct. 21, 2010

(54) Dynamic Bore Plug Assembly

(75) Inventors: Derek Kinch, Ypsilanti, MI (US); Robert Orley Burkhart, Novi, MI (US)

Correspondence Address: Kristy J. Downing, Esq., 39555 Orchard Hill Pl., 6th Fl., PMB No.: 6051, Novi, MI, 48375, US

(73) Assignee: Food Global Technologies LLC

(21) Appl. No.: 12/426,893

(22) Filed: Apr. 20, 2009

(51) Int. Cl. F16K 1/00

(52) U.S. Cl. 251/321

(57) ABSTRACT

The present disclosure relates to a hydraulic control valve assembly with a dynamic bore plug assembly that flexibly dampens valve operation. The disclosure teaches various bore plug assemblies for control valve body that can include a dynamic plug configured to restrict fluid flow out of a control valve bore. The bore plug assemblies are configured to selectively alter compressibility in the control valve bore during operation.

### TECHNICAL FIELD

The present invention relates to hydraulic control devices and, more specifically, to dynamic bore plug and accumulator plug assemblies that can be used with electro-hydraulic control assemblies.

### BACKGROUND

Conventional automatic transmissions include a hydraulic control system that governs transmission operating pressure, fluid flow distribution for cooling, lubrication and other purposes as well as the actuation of various transmission components, e.g., clutch assemblies. During control system integration and development, it was discovered that additional compliance/attenuation is required to address deficiencies in the overall system stability. These deficiencies can be manifested in a number of ways, such as: (a) solenoid instability—resulting from loss of dampening and/or inadequate system compliance; (b) excessive responses to noise inputs (e.g., driver or dither frequency, supply pressure frequency content); and (c) variability due to system environment (temperature, oil air content, etc.).

It can be difficult to predict the specific requirements for dampers due to the many possible noise factors and current software limitations. This difficulty often results in late redesigns, such as adding damper(s). As a result of this uncertainty, some control system designs overestimate packaging requirements in anticipation of the need for additional dampers. This overestimation is accompanied by significant costs attributable to unnecessary design features, such as e.g., added component/packaging size, added materials, added control assembly weight, more machining time, additional cycling time and other inefficiencies that are lost in circuit routing.

Some conventional hydraulic control systems include hydraulic accumulators in the channels of the body of the control system. Such accumulators may provide sufficient dampening in the hydraulic circuit but require additional space, parts and manufacturing operations to implement. Moreover, such accumulators are not configured to fit inside traditional regulator valve assemblies.

Therefore, it is desirable to have a hydraulic control valve assembly (or system) with a dynamic bore plug that flexibly dampens valve operation. It is further desirable to have a control valve assembly with an accumulating plug that dampens valve operation on an as-needed basis.

### SUMMARY

The present invention may address one or more of the above-mentioned issues. Other features and/or advantages may become apparent from the description which follows.

Certain embodiments of the present invention provide a bore plug assembly for a control valve, including: a dynamic plug configured to restrict fluid flow out of a control valve bore. The assembly is configured to selectively alter compressibility in the control valve bore during operation.

Some embodiments of the present invention provide a control valve assembly for a transmission, including: a first bore; a spool valve fitted in the bore, configured to move therein; and an elastomer included in the control valve assembly, configured to selectively alter compressibility in the control valve assembly during operation.

Some embodiments of the present invention provide a method of stabilizing an electro-hydraulic solenoid in a control valve assembly. The method includes: providing a control valve assembly with a plurality of bores therein; providing an electro-hydraulic solenoid in fluid communication with at least one of the plurality of bores; and providing an accumulating plug in at least one of the plurality of bores, the accumulating plug configured to selectively alter compressibility in the bore under predetermined conditions.

One advantage of some of the techniques discussed in the present disclosure is that they provide compliance after the spool valve reaches the end of its stroke, thereby maintaining solenoid stability.

Another advantage of the present invention is that it reduces the number of parts and packaging requirements for a control valve assembly.

In the following description, certain aspects and embodiments will become evident. It should be understood that the invention, in its broadest sense, could be practiced without having one or more features of these aspects and embodiments. It should be understood that these aspects and embodiments are merely exemplary and explanatory and are not restrictive of the invention.

The invention will be explained in greater detail below by way of example with reference to the figures, in which the same references numbers are used in the figures for identical or essentially identical elements. The above features and advantages and other features and advantages of the present invention are readily apparent from the following detailed description of the best modes for carrying out the invention when taken in connection with the accompanying drawings. In the figures:

### BRIEF DESCRIPTION OF THE DRAWINGS

FIG. 1 is a side view of a control valve with a bore plug assembly according to an exemplary embodiment of the present invention.

FIG. 2 is a side view of a control valve with a bore plug assembly according to an exemplary embodiment of the present invention.

FIG. 3 is a side view of a control valve with a bore plug assembly according to an exemplary embodiment of the present invention.

FIG. 4 is a side view of a control valve with a bore plug assembly according to an exemplary embodiment of the present invention.

FIG. 5 is a side view of a control valve with a bore plug assembly according to an exemplary embodiment of the present invention.

FIG. 6 illustrates a control valve assembly with an elastomer therein according to an exemplary embodiment of the present invention.

FIG. 7 illustrates a method of stabilizing an electro-hydraulic solenoid in a control valve assembly in accordance with an exemplary embodiment of the present invention.

Although the following detailed description makes reference to illustrative embodiments, many alternatives, modifications, and variations thereof will be apparent to those skilled in the art. Accordingly, it is intended that the claimed subject matter be viewed broadly.

### DETAILED DESCRIPTION

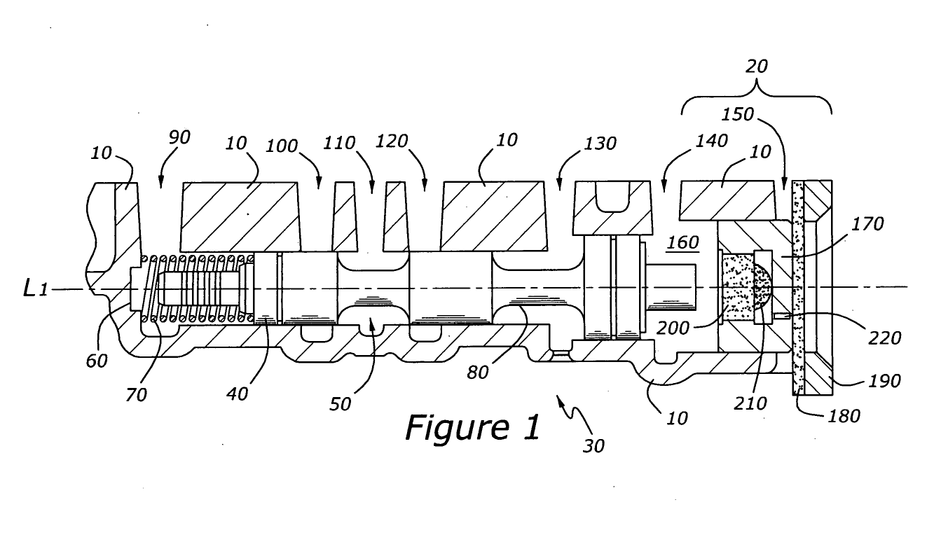

Referring to the drawings, FIGS. 1-7, wherein like characters represent the same or corresponding parts throughout the several views there is shown a number of hydraulic control valve bodies 10, 250, 500, 700 and 900 with bore plug assemblies 20, 260, 510, 710 and 910, respectively, included therein.

Referring now to FIG. 1, there is shown therein a side view of a section of a control valve body 10 (or control body) with a bore plug assembly 20. The control valve body 10 is a hydraulic control system that governs transmission operating pressure and fluid flow distribution. Control valve body 10 includes a number of regulator valve assemblies, e.g., 30, as shown in FIG. 1, that govern one or more discrete functions with respect to transmission controls. While some embodiments relate to transmission controls other applications, suitable for hydraulic control, e.g., braking systems, can be utilized with the present invention.

In the shown embodiment, the regulator valve assembly 30 includes a spool valve 40. Spool valve 40 is nested in a control valve bore 50 (or pressure chamber) in the control body 10. Spool valve 40 is biased with respect to an end wall 60 of the control valve bore 50. A coil spring 70 is positioned between the end wall 60 and the spool valve 40. Spool valve 40 is configured to move along a longitudinal axis L₁. Spool valve 40 has a variable diameter along the longitudinal axis L₁ of spool valve. The portions of the spool valve 40 having a smaller diameter (e.g., 80) act in concert with vents (e.g., 130) in control body 10 to govern the distribution of fluid through control body. In the shown embodiment, vents 90, 100, 110, 120, 130, 140 and 150 are a series of annular grooves in fluid communication with other portions of the control body 10 and/or a transmission.

The spool valve 40 of FIG. 1, can achieve various positions to regulate flow distribution in the control valve body 10. Vent 140 is in fluid communication with an electro-hydraulic solenoid that selectively provides a pressure increase to chamber 160 in the regulator valve assembly 30. In the illustrated embodiment, spool valve 40 is shown in a first position. In the first position vents 90, 110, 130 and 140 are open and allow fluid to enter/exit the control valve bore 50; vents 100, 120 and 150 are closed and fluid is substantially prevented from entering and exiting the control valve bore 50 therethrough. In a second position, the spool valve 40 is moved leftward and spring 70 is further compressed. Second position can be referred to as an “active” position because the spool valve 40 moves into the second position in response to a fluid pressure received from the electro-hydraulic solenoid at vent 140. In the second position vents 100 and 120 are open and allow fluid to enter/exit the control valve bore 50 therethrough; vents 110 and 130 are closed and fluid is substantially prevented from entering and exiting the control valve bore 50 therethrough.

The control valve bore 50 is enclosed by the bore plug assembly 20, as shown in FIG. 1. Bore plug assembly 20 substantially prevents fluid from flowing out of one end of the control valve bore 50, e.g., through vent 150. To assemble, the coil spring 70 is positioned into the bore 50, then the spool valve 40 and bore plug assembly 20 are added. In the shown embodiment, the bore plug assembly 20 includes a plug 170 that is positioned at one end of the control valve bore 50. The plug 170 abuts a retainer plate 180. The retainer plate 180 is positioned between the plug 170 and a wall 190 of the control valve body 10. The wall 190 can be a closure or cover for the control valve body 10. In one embodiment, the wall 190 includes a threaded portion and can be screwed onto the control valve body 10. Other attachment features and/or end closures can be used to seal the control valve body 10.

The plug 170 substantially prevents fluid from exiting the control valve bore 50 at vent 150. During transmission operation, sharp pressure fluctuations can occur in the control valve body 10. These pressure fluctuations can disturb solenoid stability and performance. These pressure fluctuations can, however, be substantially dampened where the compressibility of the fluid in the control valve body 10 is altered. Since compressibility is directly related to volume, increases in the volume through which fluid can flow in chamber 160 of regulator valve assembly 30 yields more compressibility throughout the control valve body 10 and greater compliance.

In the shown embodiment of FIG. 1, bore plug assembly 20 is configured to selectively alter the compressibility in the control valve body 10 during operation. Plug 170 is designed to enable the volume in chamber 160 to selectively increase/decrease. In this manner, plug 170 acts as an accumulating plug. Plug 170 includes a plunger 200 that abuts chamber 160. Plunger 200 is nested inside of a cavity formed in plug 170. An elastomer 210 is also nested in the opened end of plug 170, positioned between the plunger 200 and plug 170. Plunger 200 is sprung by the elastomer 210, which sits adjacent the plug 170. Elastomer 210 acts as a spring element and biases plunger 200 with respect to the plug 170 and wall 190 of the control body 10. Plunger 200 is configured to dynamically (or rapidly) move leftward and rightward with respect to the plug 170. As plunger 200 moves leftward and rightward, the volume in chamber 160 decreases and increases, respectively. Elastomer 210 compresses and provides an increasing force or resistance against the plunger 200 as the elastomer continues to compress. Therefore, the compression of the elastomer 210 will increase proportionally to the pressure. While an elastomer is shown, any compressible member that applies a constant or variable force against the plunger 200 can be utilized. For example, in one embodiment the plunger 200 is biased with respect to the plug 170 by a leaf spring. In another embodiment, a stop or catch is included in the control valve bore 50 to restrict movement of the plunger 200 and/or plug 170 towards chamber 160. In this way, the volume in chamber 160 can only be increased and not decreased when the pressure therein is reduced. In the shown embodiment, the plunger 200 is integrated into the plug 170 and is a portion of the plug. In other embodiments, plunger 200 is a separate component from the plug 170. In each embodiment plunger 200 and plug 170 can be composed of different materials.

Plug 170, shown in FIG. 1, also includes a small vent 220 at one end. Vent 220 enables fluid for flow from between the elastomer 210 and plug 170 when the elastomer is compressed. Vent 220 can be, for example, a cylindrical bore or slit in the plug 170. Though a singular vent is shown, multiple vents of various sizes can be included in plug 170 to adjust the pressure on the face of the elastomer 210 during compression.

In the shown embodiment, the bore plug assembly 20 alters compressibility when the pressure in chamber 160 exceeds a predetermined threshold. In the shown embodiment, elastomer 210 is configured with a sufficient stiffness so that the elastomer can still deform further after the pressure in chamber 160 exceeds the maximum normal operating pressure.

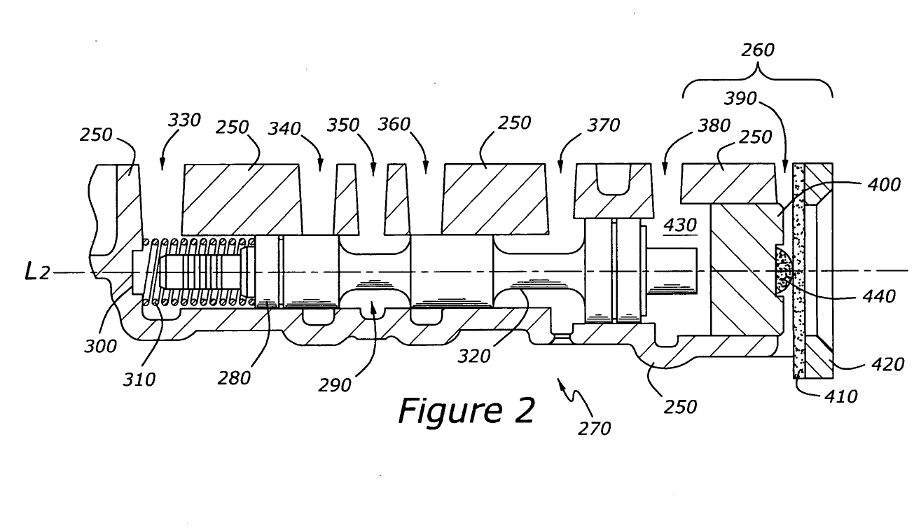

Referring now to FIG. 2, there is shown therein a side view of a section of a control valve body 250 (or control body) with a bore plug assembly 260. In the shown embodiment, a regulator valve assembly 270 includes a spool valve 280. Spool valve 280 is nested in a control valve bore 290 in the control body 250. Spool valve 280 is biased with respect to an end wall 300 of the control valve bore 290. A coil spring 310 is positioned between the end wall 300 and the spool valve 280. Spool valve 280 is configured to move along a longitudinal axis_{L2}. Spool valve 280 has a variable diameter along the longitudinal axis_{L2} of spool valve. The portions of the spool valve 280 having a smaller diameter (e.g., 320) act in concert with vents in control body (e.g., 370) to govern the distribution of fluid through control body 250. In the shown embodiment, vents 330, 340, 350, 360, 370, 380 and 390 are a series of annular grooves in fluid communication with other portions of the control body 250 and/or transmission. The spool valve 280, control body 250 and vents 330, 340, 350, 360, 370, 380 and 390 are of substantially similar configurations as the spool valve 40, control body 10 and vents 90, 100, 110, 120, 130, 140 and 150 as discussed with respect to FIG. 1. In this example, accordingly, fluid distribution throughout regulator valve assembly 270 is substantially the same as previously discussed.

The control valve bore 290 is enclosed by a bore plug assembly 260, as shown in FIG. 2. Bore plug assembly 260 substantially prevents fluid from flowing out of one end of the control valve bore 290, e.g., through vent 390. To assemble, the coil spring 310 is positioned into the bore 290, then the spool valve 280 and bore plug assembly 260 are added. In the shown embodiment, the bore plug assembly 260 includes a plug 400 that is positioned at one end of the control valve bore 290. The plug 400 approximately abuts a retainer plate 410. The retainer plate 410 is positioned between the plug 400 and a wall 420 of the control valve body 250. The wall 420 can be a closure or cover for the control valve body 250. The plug 400 substantially prevents fluid from exiting the control valve bore 290 at vent 390. Plug 400 acts as a stopper and encloses the regulator valve assembly 270.

In the shown embodiment of FIG. 2, bore plug assembly 260 is configured to selectively alter the compressibility in the control valve body 250 during operation. Plug 400 is designed to enable the volume in chamber 430 to selectively increase/decrease. In this manner, plug 400 acts as an accumulating plug. An elastomer 440 is integrated into the plug 400 and positioned between the plug 400 and retainer plate 410. Plug 400 is sprung with respect to the retainer plate 410 by elastomer 440. Elastomer 440 is nested in an open end of plug 400; elastomer 440 is adjacent plug and acts as a spring element and biases plug with respect to the retainer plate 410 and wall 420 of the control body 250. Plug 400 is configured to dynamically (or rapidly) move leftward and rightward with respect to the wall 420 of the control body 250. As plug 400 moves leftward and rightward, the volume in chamber 430 decreases and increases, respectively. Elastomer 440 compresses and provides an increasing force or resistance against the plug 400 as the elastomer 440 continues to compress. Therefore, as the pressure in chamber 430 increases the plug will move toward the retainer, increasing the volume of chamber 430 in proportion to the pressure. While an elastomer 440 is shown, any compressible member that applies a constant or variable force against the plug 400 can be utilized. A stop or catch (not shown) is included in one embodiment in the control valve bore 290 to restrict movement of the plug 400 towards chamber 430. In this way, the volume in chamber 430 can only be increased and not decreased when the pressure therein is reduced.

In the shown embodiment, the bore plug assembly 260 alters compressibility when the pressure in chamber 430 exceeds a predetermined threshold. In the shown embodiment, elastomer 440 is configured with a sufficient stiffness so that the elastomer can still deform further after the pressure in chamber 430 exceeds the maximum normal operating pressure.

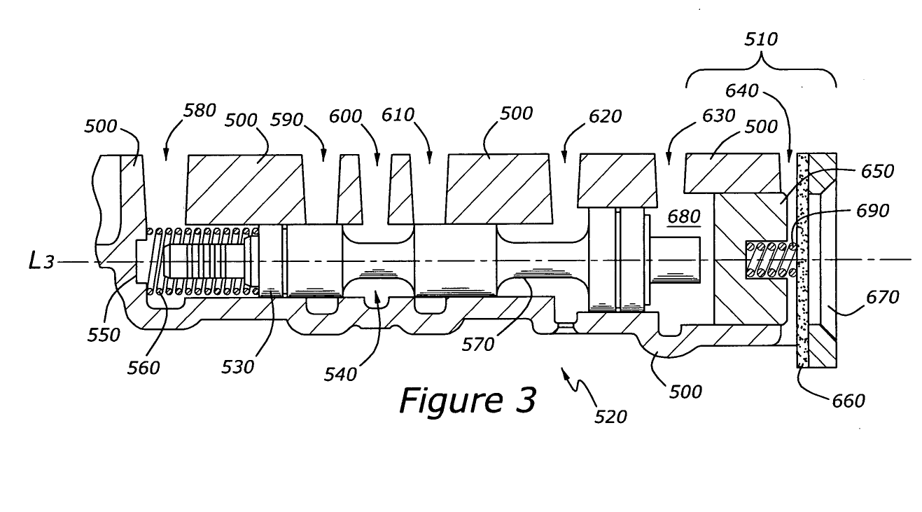

Referring now to FIG. 3, there is shown therein a side view of a section of a control valve body 500 (or control body) with a bore plug assembly 510. In the shown embodiment, a regulator valve assembly 520 includes a spool valve 530. Spool valve 530 is nested in a control valve bore 540. Spool valve 530 is biased with respect to an end wall 550 of the control valve bore 540. A coil spring 560 is positioned between the end wall 550 and the spool valve 530. Spool valve 530 is configured to move along a longitudinal axis L₃. Spool valve 530 has a variable diameter along the longitudinal axis of spool valve. The portions of the spool valve 530 having a smaller diameter (e.g., 570) act in concert with vents (e.g., 620) in control body 500 to govern the distribution of fluid through control body. In the shown embodiment, vents 580, 590, 600, 610, 620, 630 and 640 are a series of annular grooves in fluid communication with other portions of the control body 500 and/or transmission. The spool valve 530, control body 500 and vents 580, 590, 600, 610, 620, 630 and 640 are of substantially similar configurations as the spool valve 40, control body 10 and vents 90, 100, 110, 120, 130, 140 and 150 as discussed with respect to FIG. 1. In this example, accordingly, fluid distribution throughout regulator valve assembly 520 is substantially the same as previously discussed.

The control valve bore 540 is enclosed by a bore plug assembly 510, as shown in FIG. 3. Bore plug assembly 510 substantially prevents fluid from flowing out of one end of the control valve bore 540, i.e., through vent 640. To assemble, the coil spring 560 is positioned into the bore 540, then the spool valve 530 and bore plug assembly 510 are added. In the shown embodiment, the bore plug assembly 510 includes a plug 650 that is positioned at one end of the control valve bore 540. The plug 650 abuts a retainer plate 660. The retainer plate 660 is positioned between the plug 650 and a wall 670 of the control valve body 500. The wall 670 can be a closure or cover for the control valve body 500. The plug 650 substantially prevents fluid from exiting the control valve bore 540 at vent 640. Plug 650 acts as a stopper and encloses the regulator valve assembly 520.

In the shown embodiment of FIG. 3, bore plug assembly 510 is configured to selectively alter the compressibility in the control valve body 500 during operation. Plug 650 is designed to enable the volume in chamber 680 to selectively increase/decrease. In this manner, plug 650 acts as an accumulating plug. A coil spring 690 is positioned between the plug 690 and retainer plate 660. Plug 650 is sprung with respect to the retaining plate 660 by the coil spring 690. The spring 690 acts as a spring element and biases plug 650 with respect to the retainer plate 660 and wall 670 of the control body 500. Plug 650 is configured to dynamically (or rapidly) move leftward and rightward with respect to the wall 670 of the control body 500. As plug 650 moves leftward and rightward, the volume in chamber 680 decreases and increases, respectively. As spring 690 compresses it provides a variable force against plug 650. The spring force is directly proportional to the displacement of plug 650. Therefore, as the pressure in chamber 680 increases the plug 650 moves farther rightward and the restoring force applied by the spring 690 against the plug 650 increases at a predetermined rate.

While a coil spring is shown, any compressible member that applies a constant or variable force against the plug 650 can be utilized. A stop or catch (not shown) is included in one embodiment in the control valve bore 540 to restrict movement of the plug 650 towards chamber 680. In this way, the volume in chamber 680 can only be increased and not decreased when the pressure therein is reduced.

In the shown embodiment, the bore plug assembly 510 alters compressibility when the pressure in chamber 680 exceeds a predetermined threshold. In the shown embodiment, spring 690 is configured with a sufficient stiffness so that the elastomer can still deform further after the pressure in chamber 680 exceeds the maximum normal operating pressure.

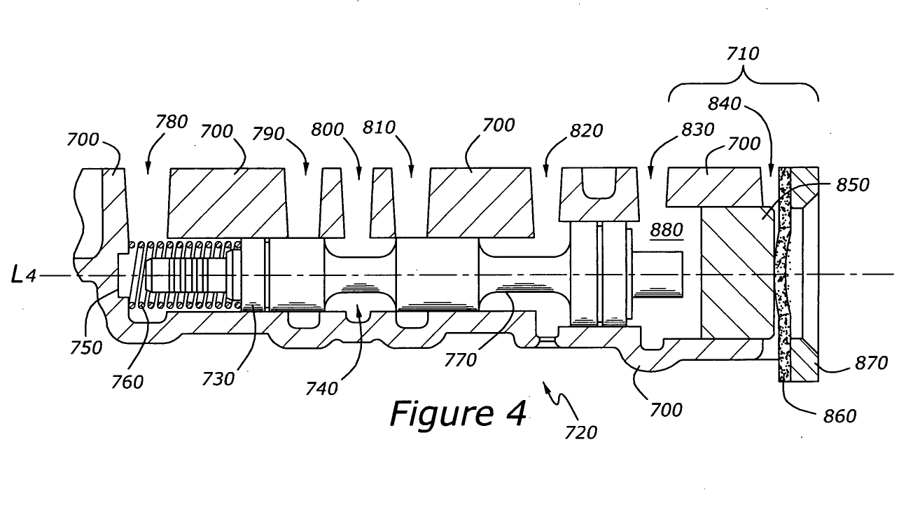

Referring now to FIG. 4, there is shown therein a side view of a section of a control valve body 700 (or control body) with a bore plug assembly 710. In the shown embodiment, a regulator valve assembly 720 includes a spool valve 730. Spool valve 730 is nested in a control valve bore 740. Spool valve 730 is biased with respect to an end wall 750 of the control valve bore 740. A coil spring 760 is positioned between the end wall 750 and the spool valve 730. Spool valve 730 is configured to move along a longitudinal axis L₃. Spool valve 730 has a variable diameter along the longitudinal axis L₃ of spool valve. The portions of the spool 730 valve having a smaller diameter (e.g., 770) act in concert with vents in control body (e.g., 820) to govern the distribution of fluid through control body 700. In the shown embodiment, vents 780, 790, 800, 810, 820, 830 and 840 are a series of annular grooves in fluid communication with other portions of the control body and/or transmission. The spool valve 730, control body 700 and vents 780, 790, 800, 810, 820, 830 and 840 are of substantially similar configurations as the spool valve 40, control body 10 and vents 90, 100, 110, 120, 130, 140 and 150 as discussed with respect to FIG. 1. In this example, accordingly, fluid distribution throughout regulator valve assembly 720 is substantially the same as previously discussed.

The control valve bore 740 is enclosed by the bore plug assembly 710, as shown in FIG. 4. Bore plug assembly 410 substantially prevents fluid from flowing out of the control valve bore 740 through vent 840. To assemble, the coil spring 760 is positioned into the bore 740, then the spool valve 730 and bore plug assembly 710 are added. In the shown embodiment, the bore plug assembly 710 includes a plug 850 that is positioned at one end of the control valve bore 740. The plug 850 abuts a deformable retainer plate 860. The retainer plate 860 is positioned between the plug 850 and a wall 870 of the control valve body 700. The wall 870 can be a closure or cover for the control valve body 700. The plug 850 substantially prevents fluid from exiting the control valve bore 740 at vent 840. Plug 850 acts as a stopper and encloses the regulator valve assembly 720.

In the shown embodiment of FIG. 4, bore plug assembly 710 is configured to selectively alter the compressibility in the control valve body 700 during operation. Plug 850 is designed to enable the volume in chamber 880 to selectively increase/decrease. In this manner, plug 850 acts as an accumulating plug. Retainer plate 860 is a leaf spring or “Belleville” spring and is positioned between the plug 850 and wall 870 of the control body 700. Plug 850 is sprung by the retainer plate 860. The plate 860 acts as a spring element and biases plug 850 with respect to the wall 870. Plug 850 is configured to dynamically (or rapidly) move leftward and rightward with respect to the wall 870 of the control body 700. As plug 850 moves leftward and rightward, the volume in chamber 880 decreases and increases, respectively. As plate 860 compresses it provides a variable force against plug 850. The spring force is directly proportional to the displacement of plug 850. Therefore, as the pressure in chamber 880 increases the plug 850 moves farther rightward and the restoring force applied by the plate 860 against the plug 850 increases at a predetermined rate. While a Belleville spring is shown, any compressible member that applies a constant or variable force against the plug 850 can be utilized. A stop or catch (not shown) is included in one embodiment in the control valve bore 740 to restrict movement of the plug 850 towards chamber 880. In this way, the volume in chamber 880 can only be increased and not decreased when the pressure therein is reduced.

In the shown embodiment, the bore plug assembly 710 alters compressibility when the pressure in chamber 880 exceeds a predetermined threshold. In the shown embodiment, plate 860 is configured with a sufficient stiffness so that the spring can still compress further after the pressure in chamber 880 exceeds the maximum normal operating pressure. It should be appreciated that there are other conditions under which bore plug assembly 710 can alter compressibility.

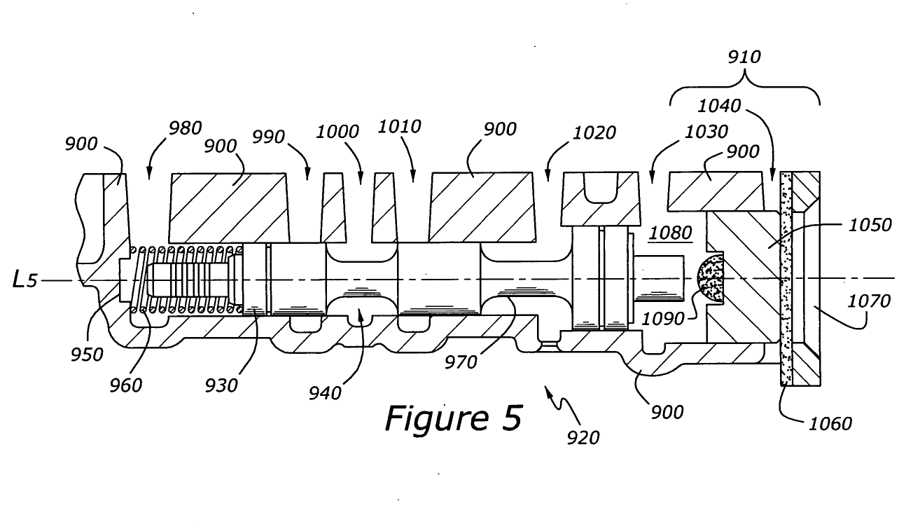

In some other exemplary embodiments of the present invention deformation of a simple elastomer is utilized to selectively alter compressibility in control valve assemblies during transmission operation. Referring now to FIG. 5, for example, there is shown therein a side view of a section of a control valve body 900 (or control body) with a bore plug assembly 910. In the shown embodiment, a regulator valve assembly 920 includes a spool valve 930. Spool valve 930 is nested in a control valve bore 940. Spool valve 930 is biased with respect to an end wall 950 of the control valve bore 940. A coil spring 960 is positioned between the end wall 950 and the spool valve 930. Spool valve 930 is configured to move along a longitudinal axis L₅. Spool valve 930 has a variable diameter along the longitudinal axis L₅ of spool valve. The portions of the spool valve 930 having a smaller diameter (e.g., 970) act in concert with vents in control body (e.g., 1020) to govern the distribution of fluid through control body 900. In the shown embodiment, vents 980, 990, 1000, 1010, 1020, 1030 and 1040 are a series of annular grooves in fluid communication with other portions of the control body 900 and/or transmission. The spool valve 930, control body 900 and vents 980, 990, 1000, 1010, 1020, 1030 and 1040 are of substantially similar configurations as the spool valve 40, control body 10 and vents 90, 100, 110, 120, 130, 140 and 150 as discussed with respect to FIG. 1. In this example, accordingly, fluid distribution throughout regulator valve assembly 920 is substantially the same as previously discussed.

The control valve bore 940 is enclosed by the bore plug assembly 910, as shown in FIG. 5. Bore plug assembly 910 substantially prevents fluid from flowing out of an end of the control valve bore 900, e.g., through vent 1040. To assemble, the coil spring 960 is positioned into the bore 940, then the spool valve 930 and bore plug assembly 910 are added. In the shown embodiment, the bore plug assembly 910 includes a plug 1050 that is positioned at one end of the control valve bore 900. The plug 1050 abuts a fixed retainer plate 1060. The retainer plate 1060 is positioned between the plug 1050 and a wall 1070 of the control valve 900. The wall 1070 can be a closure or cover for the control valve body 900. The plug 1050 substantially prevents fluid from exiting the control valve bore 940 at vent 1040. Plug acts as a stopper and encloses the regulator valve assembly 920.

In the shown embodiment of FIG. 5, bore plug assembly 910 is configured to selectively alter the compressibility in the chamber 1080 during operation. Plug is designed to enable the volume in chamber 1080 to selectively increase/decrease. In this manner, elastomer 1090 acts as an accumulating plug or component. An elastomer 1090 is a portion of the plug 1050 and is not only adjacent to plug but integrated into the plug. Elastomer 1090 is nested in an open end of the plug 1050 positioned between the plug and chamber 1080. Elastomer 1090 is deformable and acts as a spring element. As elastomer 1090 deforms it applies a pressure to the fluid in chamber 1080. The crown of elastomer 1090 is configured to dynamically (or rapidly) move leftward and rightward with respect to the wall 1070 of the control body 900. As the elastomer 1090 moves leftward and rightward, the volume in chamber 1080 decreases and increases, respectively. Elastomer 1090 compresses and provides an increasing force or resistance against fluid in chamber 1080. While an elastomer 1090 is shown, any compressible member that applies a constant or variable force against the plug 1050 can be utilized. A stop or catch (not shown) is included in one embodiment in the control valve bore 940 to restrict movement of the elastomer 1090 towards chamber beyond the positions shown in FIG. 5. In this way, the volume in chamber 1080 can only be increased and not decreased when the pressure therein is reduced.

In the shown embodiment, the bore plug assembly 910 alters compressibility when the pressure in chamber 1080 exceeds a predetermined threshold. In the shown embodiment, elastomer 1090 is configured with a sufficient stiffness so that the elastomer can still deform further after the pressure in chamber 1080 exceeds the maximum normal operating pressure. There are other conditions under which bore plug assembly 910 can alter compressibility.

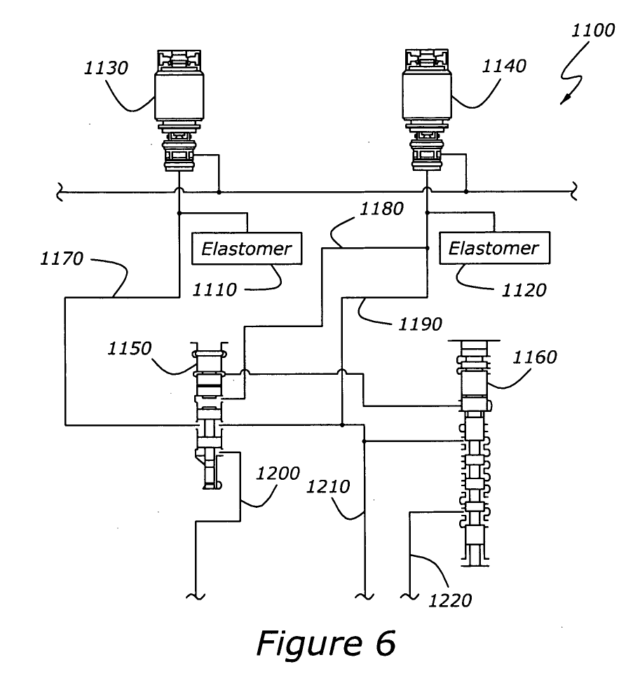

In another exemplary embodiment a simple elastomer is utilized to selectively alter compressibility in control valve assemblies during transmission operation. Referring now to FIG. 6, there is shown a schematic depiction of a segment of a control valve assembly 1100 with elastomers 1110 and 1120 that can be positioned in any location with respect to the channels of the control valve assembly (or what is commonly referred to as the “worm trails”). The control body 1100 includes two electro-hydraulic solenoids 1130 and 1140. Solenoids 1130 and 1140 are in fluid communication with a transmission pump (not shown) which is the primary fluid supply for the control valve assembly 1110. Solenoids 1130, 1140 selectively supply fluid to two regulator valves 1150 and 1160. Solenoid 1130 is configured to supply pressurized fluid to regulator valve assembly 1150 through channel 1170. Solenoid 1140 is configured to supply pressurized fluid to regulator valves 1150 and 1160 through channels 1180 and 1190, respectively. Regulator valves 1150 and 1160 can be configured to selectively supply fluid to various locations of the control valve body. For example regulator valve assembly 1150 supplies fluid to channel 1200 and regulator valve assembly 1160 supplies fluid to channels 1210 and 1220.

Elastomers 1110 and 1120 are included in channels 1170 and 1190, respectively. Elastomers 1110, 1120 are deformable and act as accumulators. As elastomers 1110, 1120 deform they increase the compliance of the fluid in the assembly 1100. While an elastomer is shown, any compressible member that changes the volume of the channel with a change in pressure in the worm trail can be utilized with a control valve body 1100. The configuration of different elastomers can vary to achieve selective deformation under predetermined conditions.

Any number of elastomers can be included with the control valve body 1100. Additionally, elastomers can be added to the control assembly as a corrective measure without redesign of structure or packaging requirements for the control valve body 1100.

The elastomers discussed herein can be designed of any number of shapes, sizes and material selections. In the shown embodiments, elastomers are composed of polymers (e.g., rubber). In some embodiments thermoplastics are used. The elastomers can be injection molded.

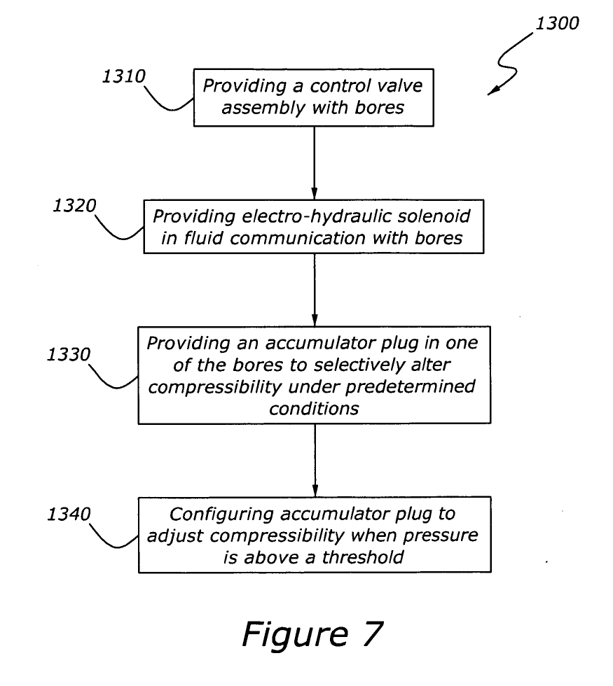

Now with respect to FIG. 7, there is shown therein a method 1300 of stabilizing an electro-hydraulic solenoid in a control valve assembly. The method includes the following steps: providing a control valve assembly with a plurality of bores therein 1310; providing an electro-hydraulic solenoid in fluid communication with at least one of the plurality of bores 1320; and providing an accumulating plug in at least one of the plurality of bores 1330. The accumulating plug is configured to selectively alter a volume in the bore under operating conditions. At step 1340 the predetermined condition is a pressure in excess of a threshold amount in the control valve assembly. The accumulator plug is configured to adjust compressibility in the channel.

In the shown embodiments, control body, spool valves, plugs and plungers are composed of metallic materials (e.g., steel or aluminum alloys). Persons in the art will appreciate that these components can be composed of other materials as well (e.g., hard plastics). Plugs and plungers can be formed using any know forming techniques, such as for example, molding, stamping, extrusion or lathing.

Though the illustrated embodiments relate to bore plug assemblies that selectively vary compressibility in a control valve body using sprung elements and elastomers, it should be appreciated that other devices can be used to selectively alter the volume in the control valve body. For example, the bore plug assembly can be electronically or hydraulically actuated. Accumulator architecture, e.g. pistons and shock absorbers, can be integrated into the plug to enable a portion of the plug to move with respect to the control valve bore.

For the purposes of this specification and appended claims, unless otherwise indicated, all numbers expressing quantities, percentages or proportions, and other numerical values used in the specification and claims, are to be understood as being modified in all instances by the term “about.” Accordingly, unless indicated to the contrary, the numerical parameters set forth in the written description or claims are approximations that can vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

It is noted that, as used in this specification and the appended claims, the singular forms “a,” “an,” and “the,” include plural referents unless expressly and unequivocally limited to one referent. Thus, for example, reference to “a bore plug assembly” includes two or more different bore plug assemblies. As used herein, the term “include” and its grammatical variants are intended to be non-limiting, such that recitation of items in a list is not to the exclusion of other like items that can be substituted or added to the listed items.

It will be apparent to those skilled in the art that various modifications and variations can be made to the methodologies of the present disclosure without departing from the scope of its teachings. Other embodiments of the invention will be apparent to those skilled in the art from consideration of the specification and practice of the teachings disclosed herein. It is intended that the specification and examples be considered as exemplary only.

While the best modes for carrying out the invention have been described in detail, those familiar with the art to which this invention relates will recognize various alternative designs and embodiments for practicing the invention within the scope of the appended claims.

1. A bore plug assembly for a control valve body, comprising:
a dynamic plug configured to restrict fluid flow out of an end of a control valve bore;
wherein the assembly is configured to selectively alter compressibility in the control valve bore during operation.

2. The assembly of claim 1, further comprising:
a spring element positioned to bias a portion of the plug with respect to a control valve body wall.

3. The assembly of claim 2, wherein the spring element is integrated into the plug.

4. The assembly of claim 2, wherein the plug includes an open end and wherein the spring element comprises an elastomer nested in the open end of the plug.

5. The assembly of claim 4, wherein the plug comprises a plunger biased with respect to the plug.

6. The assembly of claim 5, wherein the plunger is biased by the elastomer.

7. The assembly of claim 4, wherein the elastomer is positioned between the plug and the control valve body wall.

8. The assembly of claim 2, wherein the spring element comprises a coil spring.

9. The assembly of claim 2, wherein the spring element comprises a Belleville spring positioned between the plug and the control valve body wall.

10. A control valve assembly for a transmission, comprising:
a bore;
a spool valve fitted in the bore, configured to move therein; and
an elastomer included in the control valve assembly, configured to selectively alter compressibility in the control valve assembly during operation.

11. The assembly of claim 10, further comprising:
a channel having the elastomer fitted therein.

12. The assembly of claim 11, further comprising:
a plug included in the bore, configured to restrict fluid flow out of one end of the bore; and
another elastomer included in the bore.

13. The assembly of claim 10, further comprising:
a plug included in the bore, configured to restrict fluid flow out of an end of the bore;
wherein the elastomer is included in the bore.

14. The assembly of claim 13, wherein the elastomer is nested in the plug.

15. The assembly of claim 13, wherein the elastomer is configured to bias the plug with respect to the end of the bore.

16. The assembly of claim 13, wherein the plug comprises a plunger biased with respect to the end of the bore by the elastomer.

17. The assembly of claim 13, further comprising:
a spring element positioned to bias the plug with respect to the end of bore.

18. The assembly of claim 17, wherein the spring element is a coil spring.

19. A method of stabilizing an electro-hydraulic solenoid in a control valve assembly, comprising:
providing a control valve assembly with a plurality of regulator valve bores therein;
providing an electro-hydraulic solenoid in fluid communication with at least one of the regulator valve bores; and
providing an accumulating plug in at least one of the regulator valve bores, the accumulating plug configured to selectively alter compressibility in the regulator valve bore under predetermined conditions.

20. The method of claim 19, configuring accumulating plug so that the predetermined condition is a pressure in excess of a threshold amount in the control valve assembly.
